(19) United States
(12) Patent Application Publication
(10) Pub. No.: US 2021/0252426 A1
(43) Pub. Date: Aug. 19, 2021

(54) Drying System, Dryer Cartridge, and Use of a Dryer Cartridge

(71) Applicant: MANN+HUMMEL GmbH, Ludwigsburg (DE)

(72) Inventors: Alexander Traut, Bad Rodach (DE); Marius Panzer, Ludwigsburg (DE)

(21) Appl. No.: 17/194,663

(22) Filed: Mar. 8, 2021

Related U.S. Application Data
(63) Continuation of application No. PCT/EP2019/071997, filed on Aug. 16, 2019.

(30) Foreign Application Priority Data
Sep. 11, 2018 (DE) 10 2018 122 073.1

(51) Int. Cl. B01D 17/02; B01J 20/18

(52) U.S. Cl. CPC B01D 17/0202; B01J 20/28085; B01D 2253/108; B01J 20/18

(57) ABSTRACT

A drying system for removal of water from a liquid is provided with a device for receiving the liquid and a dryer cartridge with a cartridge body and a connection head arranged at the cartridge body. The cartridge body has a cartridge body wall delimiting a receiving chamber, at least in sections thereof, wherein the cartridge body wall allows the liquid to pass into and out of the receiving chamber. A drying agent is received in the receiving chamber. The connection head of the dryer cartridge is fastened to a housing wall of the device for receiving the liquid and secures the dryer cartridge at the device for receiving the liquid so that the cartridge body is fixed relative to the housing wall.

### CROSS-REFERENCE TO RELATED APPLICATIONS

This application is a continuation application of international application No. PCT/EP2019/071997 having an international filing date of 16 Aug. 2019 and designating the United States, the international application claiming a priority date of 11 Sep. 2018 based on prior filed German patent application No. 10 2018 122 073.1, the entire contents of the aforesaid international application and the aforesaid German patent application being incorporated herein by reference.

### TECHNICAL FIELD

The invention concerns a drying system for removing water from a fluid, in particular oil, comprising a device for receiving the fluid and a dryer cartridge with a cartridge body that forms a receiving chamber in which a drying agent is received, wherein the receiving chamber, at least in sections thereof, is delimited by a wall of the cartridge body through which the fluid can flow. Moreover, the invention concerns a dryer cartridge and a use of a dryer cartridge.

### BACKGROUND OF THE INVENTION

In fluid-conducting systems, it may happen that water collects in the fluid due to various processes. The water can reach the system, for example, by air exchange with the environment and collect in the fluid. Likewise, free water can be introduced into the system from the environment. This water can also be produced as a reaction product of a chemical reaction, for example, of a combustion. The water can be present in the fluid as free or dissolved water. The water in the fluid can cause undesirable effects such as, for example, corrosion of fluid-conducting components of the system, an increase or decrease of the electrical conductivity of the fluid and/or reduction of the service life of the fluid, i.e., a shortening of service intervals. In addition, the system can block at temperatures below 0° C. due to ice crystal formation.

U.S. Pat. No. 4,861,469 A discloses a dewatering device for a fuel tank that is introduced into the tank and removed from the tank through the tank opening. The device comprises an elongated cylindrical container. A small portion of the container volume is filled with a hygroscopic material. The container is held at an elongate strap which is fastened close to the tank opening so that it is accessible. The length of the strap is selected to be so large that the container sinks to the bottom of the tank in order to absorb water that is present thereat. The position of the container cannot be controlled in this device. In addition, the container during its use can move freely inside the tank, for example, when the tank is accelerated.

### SUMMARY OF THE INVENTION

It is object of the invention to provide a drying system for removing water from a liquid fluid, in which a dryer cartridge can be arranged and aligned in a targeted fashion inside a device for receiving the fluid. Furthermore, it is object of the invention to provide a dryer cartridge suitable therefor and to disclose its advantageous use.

This object is solved by a drying system for removal of water from a liquid, in particular oil, comprising:

a device for receiving the liquid, and

a dryer cartridge with a cartridge body which forms a receiving chamber in which a drying agent is received, wherein the receiving chamber, at least in sections thereof, is delimited by a wall of the cartridge body through which the liquid can flow, and with a connection head,

wherein the dryer cartridge by means of the connection head is fastened at a housing wall of the device for receiving the liquid, preferably in a releasable manner, so that the cartridge body is fixed relative to the housing wall.

The object is further solved by a dryer cartridge for a drying system as disclosed above, that comprises a cartridge body that forms a receiving chamber in which at least one drying agent for absorbing water from a liquid is received, wherein the receiving chamber, at least in sections thereof, is delimited by a wall of the cartridge body through which the fluid can flow, and that comprises a connection head, wherein the dryer cartridge by means of the connection head can be fastened to a housing wall of a device for receiving the liquid in such a way that the cartridge body is fixed relative to the housing wall.

The object is further solved by a use of a dryer cartridge that comprises a cartridge body that forms a receiving chamber in which at least one drying agent for absorbing water is received, wherein the receiving chamber, at least in sections thereof, is delimited by a wall of the cartridge body through which the liquid can flow, and that comprises a connection head, for drying a liquid, in particular for drying oil, wherein the dryer cartridge is fastened by means of the connection head to a housing wall of a device containing the liquid, preferably in a releasable manner, so that the cartridge body is fixed relative to the housing wall.

Preferred embodiments are disclosed in the respective dependent claims and the description.

The drying system according to the invention serves for removing water from a liquid fluid. The fluid can be in particular oil, for example, lubricant oil, cooling oil, insulating oil, and/or a liquid on the basis of glycol, for example, braking fluid. The drying system comprises a device for receiving the fluid. In operation of the drying system, the fluid is received in the device. The drying system comprises moreover a dryer cartridge with a cartridge body. The cartridge body forms a receiving chamber in which a drying agent is received. In use, the drying agent can remove water from the fluid and permanently retain it inside the receiving chamber. The drying agent stores the water, for example, by adsorption of the water molecules on its surface. The receiving chamber, at least in sections thereof, is delimited by a wall of the cartridge body through which the fluid can flow. Preferably, the receiving chamber is substantially delimited by a wall through which the fluid can flow, i.e., a predominant portion of the wall is permeable to the liquid. In this way, a sufficient contact with the fluid is provided for an efficient drying action. In use, the fluid with the water contained therein can flow into the receiving chamber through the wall that can be flowed through and contact the drying agent therein. The drying agent can remove water from the fluid. Fluid with an at least reduced water proportion can exit again from the receiving chamber through the wall that can be flowed through. Preferably, the wall is configured to be substantially fluid-permeable about the entire circumference so that the fluid can radially flow in and out about the entire circumference.

The dryer cartridge is embodied together with a connection head. The dryer cartridge is fastened by means of the connection head at a housing wall of the device for receiving the fluid, preferably in a releasable way, so that the cartridge body is fixed relative to the housing wall. A releasable connection enables a simple exchange of the dryer cartridge, for example, when the water absorption capacity of the drying agent is exhausted. By fixing the cartridge body relative to the housing wall, it can be ensured that the receiving chamber with the drying agent is located always in a predefined position inside the device for receiving the fluid. In this way, it can also be avoided that the position of the cartridge body changes during the use of the drying system. Therefore, it can be achieved that the receiving chamber with the drying agent is always in a position suitable for drying the fluid. Moreover, it is avoided that the cartridge body damages components of the device for receiving the system because it cannot move dynamically inside the device. The cartridge body is typically completely fixed relative to the housing wall. The cartridge body or the entire dryer cartridge can be embodied rigidly.

Preferably, the receiving chamber is delimited by a support grid comprising a plurality of openings and its openings are covered by a liquid-permeable medium. The dryer cartridge can advantageously be integrated into an existing device for receiving the fluid in order to obtain in this way a drying system according to the invention without greater modifications being required at the device for receiving the fluid. In particular, by fixation of the cartridge body at the wall, there is no danger that it comes into contact with other components of the device for receiving the fluid. In addition, it can be ensured that the drying agent always sufficiently contacts the fluid.

Aspects of the below described use of the drying cartridge can be additionally realized in the drying system according to the invention.

The wording “removal of water from the fluid” and “drying of the fluid” are used synonymously in the context of the present invention. The fluid to be dried is a liquid that also in the “dry” state, i.e., free of water, is present in a liquid aggregation state.

Preferably, the dryer cartridge is fastened with form fit to the housing wall. This simplifies the attachment and enables a particularly precise alignment of the cartridge body of the dryer cartridge. The form fit prevents preferably a pure translation of the dryer cartridge relative to the housing wall in any spatial direction. Typically, the cartridge body in the fastened state cannot move—neither by translation nor rotation—relative to the housing wall.

The dryer cartridge can be fastened in an opening of the housing wall. This simplifies the insertion and exchange of the dryer cartridge. Preferably, the dryer cartridge is screwed into the opening of the housing wall. In this way, the dryer cartridge can be fixed safely at the housing wall. In addition, the attachment or exchange of the dryer cartridge can be done quickly and easily. Alternatively or additionally, the dryer cartridge can be fastened by means of a bayonet connection in the opening and/or can be clipped into the opening and/or can be snapped into the opening and/or can be fastened by means of a pushed-on clip in the opening. This can further accelerate the attachment or exchange of the dryer cartridge and/or additionally secure the attachment.

Advantageously, a sealing element is arranged between the connection head of the dryer cartridge and the housing wall surrounding the opening. In this way, escape of fluid from the opening can be prevented reliably. The sealing element can comprise an O-ring, a shaped seal and/or a flat seal. The sealing element can comprise alternatively or additionally a sealing lip. The sealing element can be designed as a two-component seal. Typically, the sealing element is held at the connection head with form fit, for example, in a groove, so that it can be exchanged together with the dryer cartridge. Alternatively, the sealing element can be injection molded to the connection head.

The dryer cartridge can be fastened in a compensation tank of the device for receiving the fluid. The compensation tank serves in particular for compensation of heat-caused volume changes and/or of fluctuations of the volume of the fluid contained in the device. Typically, the fluid is supplied in operation from the compensation tank to a further component of the device for receiving the fluid and then returned to the compensation tank. In the compensation tank, the dryer cartridge reliably contacts the fluid to be dried. In addition, the compensation tank can be adapted for accommodating the dryer cartridge without this having an effect on further components of the device for receiving the fluid. The dryer cartridge can absorb condensation water, for example.

The drying agent can comprise an adsorber material. Preferably, the drying agent has a porous crystal structure so that the water can be adsorbed at its inner surface. In particular, the drying agent can comprise a molecular sieve, for example, a zeolite molecular sieve. Molecular sieves are advantageously used for low concentrations of dissolved water in the liquid. The adsorber material can comprise a framework silicate. The drying agent can comprise different types of zeolite molecular sieves. The drying agent can comprise natural or synthetic zeolites. The drying agent can comprise bentonite/clay minerals, for example, containing aluminum oxide, calcium sulfate, calcium carbonate; the aforementioned drying agents can be regenerated. Also, the drying agent may comprise bentonite/clay minerals that cannot be regenerated, for example, containing calcium, calcium hydride, calcium oxide, calcium sulfate, potassium hydroxide, copper sulfate, lithium aluminum hydride and/or sodium hydroxide.

The pore size of the employed molecular sieves is selected such that an adsorption of water molecules is possible. Suitable molecular sieves comprise typically a mesh width (pore size) of 3 to 4 angstrom.

The drying agent, in particular in the form of zeolite molecular sieves, can be present as a powder, for example, with an average particle size of 5 μm to 10 μm (pure form of zeolite). Alternatively or additionally, the drying agent, in particular in the form of zeolite molecular sieves, can be present in a bead shape (e.g., 0.1 mm to 50 mm in diameter), in rod shape, as a hollow fiber membrane, as mixture of polymer and drying agent, as moldings, as solid body and/or as shaped body (in particular of composite material), preferably with a sponge or honeycomb structure.

The dryer cartridge can be manufactured at least partially from a composite material on the basis of polymer, which contains drying agent (e.g. zeolite) as well as channel formers for producing mesopores in the polymer material.

The drying agent can comprise two different drying agent components. The different drying agent components differ in their properties. At least one of the drying agent components comprises an adsorber material for adsorption of water from a liquid, in particular a molecular sieve, e.g., a zeolite molecular sieve. In particular, the two drying agent components can be arranged so as to be separated spatially from each other in the receiving chamber. In this way, it can be advantageously provided that one of the drying agent components, preferably containing a molecular sieve, is immersed in the liquid to be dried while the other drying agent component, a drying agent for drying air, preferably a silica gel, is arranged in a head space above the liquid. Silica gels are suitable in particular for drying air and fluids with high concentrations of dissolved water. Silica gels can indicate an exhaustion of the water absorption capacity by color change. For this purpose, cobalt chlorite and/or methyl violet (orange gel) can be used as color indicator, for example. The silica gels can have an average pore size of 25 nm or 65 nm. Silica gel can be present in the form of alumino silicate.

The wall of the cartridge body through which the fluid can flow can be designed as a single or multi-part screen, comprised of one or a plurality of materials, a spunbond material, a nonwoven and/or a filter medium. These materials allow the fluid to pass through (flow through). At the same time, they are suitable for retaining the drying agent in the receiving chamber, in particular also for retaining abraded particles or fragments of the drying agent. A mesh width of the aforementioned materials can amount to at least 1 μm and/or at most 5,000 μm. Preferably, the wall is formed with synthetic materials.

The drying agent can be arranged in a drying agent bag which is received in the receiving chamber. This simplifies the introduction of the drying agent into the receiving chamber. The fluid can flow through the material of the drying agent bag. When the receiving chamber is designed to be openable in a reclosable manner, the drying agent can be exchanged in a simple way so that the dryer cartridge can be furthermore reused. For example, the receiving chamber can be provided with a removable cover at an end that is opposite the connection head.

Preferably, the device for receiving the fluid of the above-described drying system contains the fluid. Accordingly, this is referred to also as the device containing the fluid. The dryer cartridge can be arranged such that the drying agent of the dryer cartridge is partially immersed in the fluid and partially is arranged in a head space above the fluid.

The drying system can comprise a moisture sensor, in particular a capacitive moisture sensor. The latter can measure the moisture (the water content) of the fluid. In this way, it is detected when the water absorption ability (water absorption capacity) of the drying agent is exhausted and a satisfactory drying of the fluid no longer occurs. Alternatively or additionally, the drying system can have an inspection glass in which a color change takes place when the water content of the fluid surpasses a limit value.

The present invention also encompasses a dryer cartridge for the afore described drying system. With the dryer cartridge according to the invention, the corresponding aforementioned advantages can be utilized.

Moreover, the invention concerns a use of a dryer cartridge which comprises a cartridge body that forms a receiving chamber in which a drying agent is received, wherein the receiving chamber, at least in sections thereof, is delimited by a wall of the cartridge body through which the fluid can flow, and which comprises a connection head. According to the invention, the dryer cartridge is used for drying a fluid, in particular for drying oil, wherein the dryer cartridge by means of the connection head is fastened, preferably in a releasable manner, to a housing wall of a device containing the fluid, so that the cartridge body is fixed relative to the housing wall. In this way, it is ensured that the cartridge body during the use of the dryer cartridge is arranged in a defined position and orientation relative to the housing wall. In this way, the drying effect can be improved and damages to components of the device containing the fluid can be avoided. The dryer cartridge and the device containing the fluid can comprise advantageously the further features of an above described drying system. In the context of the use according to the invention, the “device for receiving the fluid” mentioned in the drying system contains the fluid so that this is referred to here as the “fluid-containing device”. Due to drying of the fluid, it can be in particular avoided that free water or (water) ice crystals form in the fluid. The fluid comprises typically a lower freezing point than water. In addition, a growth of microbes, for example, bacteria, can be prevented by removing water from the fluid. The saturation concentration in the fluid to be dried at typical temperatures is typically in the range of 1 to 10,000 ppm (parts per million).

The drying agent of the dryer cartridge can be immersed partially in the fluid and partially be arranged in a head space above the fluid. In this way, at the same time the air above the fluid can be dried (dehumidified) and also the fluid itself can be dried. For this purpose, the dryer cartridge can comprise preferably two different drying agent components that, particularly preferred, are arranged spatially separated from each other in the receiving chamber. Typically, the receiving chamber is immersed by about two thirds in the fluid.

The fluid can be an electrically nonconducting insulation oil, in particular transmission oil and/or cooling oil. In particular, the insulation oil can contain a polyol ester oil and/or a poly-alpha-olefin. In case of insulation oils, a removal of the dissolved or free water is particularly important in order to maintain the insulating properties of the insulation oil. Insulation oils are used, for example, in electrical devices such as transformers, capacitors, and/or batteries/rechargeable batteries. The insulation oil can act at the same time as a cooling oil for heat dissipation. The fluid can furthermore be a cooling agent, for example, halogenated or non-halogenated hydrocarbons, in particular hydrofluorocarbon, or hydrofluoroether.

The fluid can contain a dialcohol.

The device containing the fluid can be an internal combustion engine, a transmission and/or a braking system. The device containing the fluid can be a fuel cell, a transformer, and/or a rechargeable battery. In these devices, drying of the fluid in the device is particularly important. The aforementioned devices can be, for example, a part of a motor vehicle or can be designed otherwise to be mobile. The use can be realized in a locomotive or a rail car; the device containing the fluid can correspondingly comprise a locomotive or a rail car. The use can also be realized in a buffer battery; the device containing the fluid can thus comprise a buffer battery that can serve, for example, for intermediate storage of regeneratively generated electrical energy and its supply into a power network. The fluid is typically a cooling liquid, in particular a cooling oil. The fluid can exhibit at the same time electrically insulating properties of an insulating oil.

Advantageously, the dryer cartridge is part of a thermal management module comprising a container for the fluid in which the dryer cartridge is introduced, at least one filter or a screen for the fluid, a fluid pump, at least one sensor for moisture and/or temperature and/or pressure, and a cooling device. Such a module can be coupled, for example, with a transmission, a battery, or a rechargeable battery, an electric motor, combustion engine, power electronics, transformer or a braking system.

By means of the dryer cartridge, water, in particular condensation water, can be removed from an oil circuit, for example.

### BRIEF DESCRIPTION OF THE DRAWINGS

Further features and advantages of the invention result from the following detailed description of embodiments of the invention, from the claims as well as based on the Figures of the drawing showing details according to the invention. The aforementioned and still to be described features can be realized individually on their own or several combined in any combinations in variants of the invention. The features disclosed in the drawing are illustrated such that the particularities according to the invention can be made clearly visible.

FIG. 1 shows a drying system with a dryer cartridge which is screwed into an opening of a compensation tank, in a schematic perspective view with partially sectioned compensation tank.

FIG. 2 shows a dryer cartridge of a drying system in a schematic side view.

FIG. 3 shows a dryer cartridge of a drying system in a schematic longitudinal section.

### PREFERRED EMBODIMENTS OF THE INVENTION

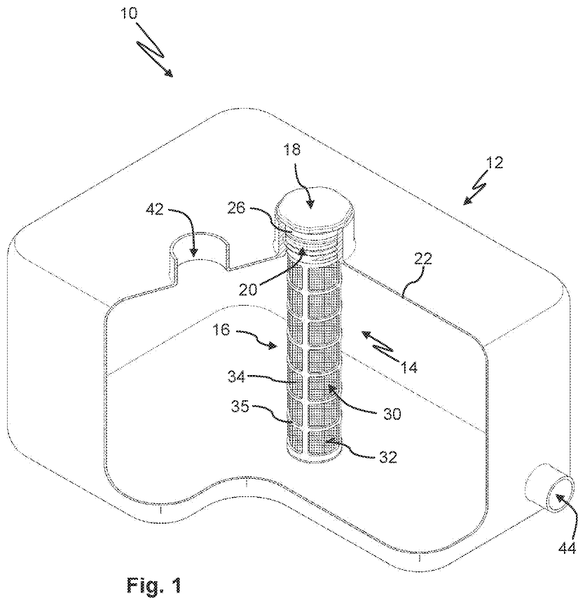

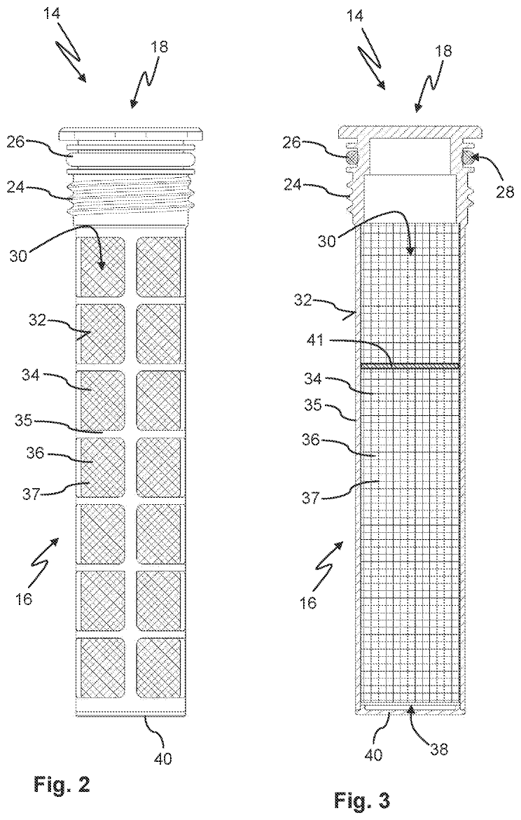

FIG. 1 shows a drying system 10. The drying system 10 comprises a device for receiving a fluid. The device for receiving the fluid comprises here a compensation tank 12, i.e., a container which is filled in changing ratios partially with the liquid and partially with air. The compensation tank 12 is illustrated in FIG. 1 partially sectioned. The drying system 10 comprises furthermore a dryer cartridge 14. In regard to the construction of the dryer cartridge 14, reference is being had additionally to FIGS. 2 and 3.

The dryer cartridge 14 comprises a cartridge body 16 and a connection head 18. The cartridge body 16 and the connection head 18 are here embodied together as one piece as an injection molded part of plastic material.

The dryer cartridge 14 is screwed with its connection head 18 into an opening 20 of a housing wall 22 of the compensation tank 12. The connection head 18 is provided with an outer thread 24 for this purpose. By being screwed into the opening 20, the dryer cartridge 14 is connected with form fit to the housing wall 22 of the compensation tank 12. For sealing, a sealing element 26, here an O-ring, is provided that is arranged between the connection head 18 and the housing wall 22 forming the opening 20. For receiving the sealing element 26, the connection head 18 comprises a groove 28 in which the sealing element 26 is held in the not yet mounted state of the dryer cartridge 14.

By attachment of the connection head 18 at the housing wall 22, the cartridge body 16 is fixed relative to the housing wall 22. In the fastened state, the cartridge body 16 cannot move relative to the compensation tank 12. The dryer cartridge 14 with the cartridge body 16 and the connection head 18 is embodied here as a whole as a rigid component. By screwing the connection head 18 into the opening 20 of the housing wall 22, in particular a pure translation of the cartridge body 16 relative to the housing wall 22 is prevented. Here, the only possible movement of the dryer cartridge 14 relative to the compensation tank 12 is a screwing movement (combined translation and rotation that are coupled by the thread pitch of the outer thread 24). Without releasing the attachment of the connection head 18 at the housing wall 22, the cartridge body 16 is typically (thus also here) not movable—neither by translation nor rotation—relative to the housing wall 22.

Alternative embodiments of the drying system 10 with the dryer cartridge 14 are conceivable in which the cartridge body 16 in the fastened state of the connection head 18 is rotatable, for example, about a longitudinal axis of the cartridge body 16 without the (translatory) position of the cartridge body 16 being changed, by the way. For this purpose, the connection head 18 can be embodied, for example, round in cross section and can be secured at the opening 20 by being clipped by means of a pushed-on clip (not illustrated).

The cartridge body 16 forms a receiving chamber 30. The receiving chamber 30 is surrounded by a cartridge body wall 32 through which the fluid can flow. The wall 32 that can be flowed through is here formed by a screen 34. The screen 34 can be formed as one piece together with the cartridge body 16. Presently, the screen 34 is embodied as a component separate from the cartridge body 16 and is inserted into the cartridge body 16. The screen 34 is supported, here from the interior, by a grid-type support structure 35 of the dryer cartridge 14. The screen can comprise pores (meshes) 36 with a pore size (mesh width) of, for example, 150 μm. In FIG. 2, threads 37 that are forming the screen 34 are illustrated extending at a slant to the longitudinal axis of the cartridge body 16. In FIG. 3, the threads 37 of the screen 34 are illustrated so as to extend transversely and parallel to the longitudinal axis of the cartridge body 16. In other respects, the dryer cartridges 14 according to FIGS. 2 and 3 are identically constructed.

The cartridge body 16 comprises here a venting opening 38 at the bottom end. After insertion of the screen 39 and filling the drying agent into the receiving chamber 30, the fill opening 38 is closed by means of a cover part 40. The cover part 40 is glued or welded here to the cartridge body 16.

In the receiving chamber 30, drying agent (not illustrated in detail) is received. The drying agent comprises here two different drying agent components, i.e., a silica gel and a zeolite molecular sieve. The two drying agent components are arranged, separated spatially from each other, in the receiving chamber 30. For this purpose, a separation element 41 can divide the receiving chamber 30, preferably transversely to its longitudinal direction. The silica gel is arranged in the receiving chamber 30 closer to the connection head 18. Facing away from the connection head 18, i.e., here closer to the cover part 40, the zeolite molecular sieve is arranged.

In an alternative embodiment of the dryer cartridge 14, not illustrated in detail, the drying agent can be accommodated in one or a plurality of drying agent bags that, in turn, are arranged in the receiving chamber 30. The drying agent bag or bags can be provided instead of or in addition to the screen 34. A first drying agent bag can contain a first drying agent component and a second drying agent bag can contain a second drying agent component. When using drying agent bags, a separation element in the receiving chamber 30 for spatial separation of the drying agent components can be dispensed with. The drying agent can be present in bead shape and filled into the drying agent bag.

In the receiving chamber, an elastic element, for example, a spring, can be arranged which produces a pretension so that the drying agent is arranged substantially immobile in the dryer cartridge 14 during operation. For example, the elastic element is arranged between cover part 40 and drying agent or between drying agent and connection head. Due to the elastic element, abrasion of the drying agent is avoided, in particular in case that the drying agent is present in the form of beads because a relative movement of the beads is prevented or at least reduced.

The drying system 10 comprises here, in addition to the compensation tank 12 and the dryer cartridge 14, an electrical device, namely a rechargeable battery (not illustrated on detail). The rechargeable battery serves as a buffer battery for intermediate storage of regeneratively produced electrical energy and its supply to a power network, for example, of an residential building.

In operation of the drying system 10, fluid, not illustrated in detail, is contained in the compensation tank 12. The fluid is here an electrically nonconducting insulation oil which is employed for cooling the electrical device, i.e., here the rechargeable battery. The fluid flows through an inlet 42 into the compensation tank 12. Through an outlet 44, the fluid is then returned again to the electrical device. In this way, a fluid level is adjusted in the compensation tank 12. The compensation tank 12 is typically filled approximately to one half or three fourths with the fluid. By temperature-caused volume change of the fluid, a filling level of the fluid in the compensation tank 12 fluctuates in operation. Also, loss or refill of fluid leads to a change of the filling level in the compensation tank 12.

In operation of the drying system 10, the receiving chamber 30 of the cartridge body 16 is partially immersed in the fluid and partially arranged in a head space above the fluid. Typically, the receiving chamber 30 is immersed with about two thirds of its length in the fluid. The immersion depth can fluctuate due to the above described changes of the fluid level during the operation of the drying system 10, i.e., during the use of the dryer cartridge 14. The two different drying agent components are arranged such in the receiving chamber 30 that, for a usual filling level (fluid level) in the compensation tank 12, a first drying agent component, here the silica gel, is located in the head space above the fluid. A second drying agent component, here the zeolite molecular sieve, is immersed in the fluid at the usual fluid level. In this way, an efficient drying of the air in the compensation tank 12 as well as of the fluid can be effected.

What is claimed is:

1. A drying system for removal of water from a liquid, the drying system comprising:
a device for receiving the liquid;
a dryer cartridge comprising a cartridge body and a connection head arranged at the cartridge body;
wherein the cartridge body comprises a cartridge body wall delimiting a receiving chamber, at least in sections thereof, wherein the cartridge body wall is configured to allow the liquid to pass into and out of the receiving chamber;
a drying agent received in the receiving chamber;
wherein the connection head of the dryer cartridge is fastened to a housing wall of the device for receiving the liquid and secures the dryer cartridge at the device for receiving the liquid so that the cartridge body is fixed relative to the housing wall.

2. The drying system according to claim 1, wherein the connection head of the dryer cartridge is releasably connected to the housing wall of the device for receiving the liquid.

3. The drying system according to claim 1, wherein the dryer cartridge is fastened with form fit to the housing wall.

4. The drying system according to claim 1, wherein the housing wall comprises an opening and wherein the dryer cartridge is fastened in the opening of the housing wall.

5. The drying system according to claim 4, wherein the connection head of the dryer cartridge is screwed into the opening of the housing wall.

6. The drying system according to claim 5, further comprising a sealing element arranged between the connection head of the dryer cartridge and a housing wall portion of the housing wall surrounding the opening.

7. The drying system according to claim 6, wherein the sealing element comprises one or more seals selected from the group consisting of an O-ring, a shaped seal, and a flat seal.

8. The drying system according to claim 1, wherein the device for receiving the liquid comprises a compensation tank and wherein the dryer cartridge is fastened in the compensation tank.

9. The drying system according to claim 1, wherein the drying agent comprises an adsorber material.

10. The drying system according to claim 9, wherein the adsorber material is a molecular sieve.

11. The drying system according to claim 10, wherein the molecular sieve is a zeolite molecular sieve.

12. The drying system according to claim 1, wherein the drying agent comprises two different drying agent components.

13. The drying system according to claim 13, wherein the two different drying agent components are arranged spatially separated from each other in the receiving chamber or are uniformly distributed in the receiving chamber.

14. The drying system according to claim 1, wherein the cartridge body wall comprises one or more elements selected from the group consisting of a screen, a spunbond material, a nonwoven, and a filter medium.

15. The drying system according to claim 1, wherein the cartridge body wall comprises pores with a pore size in a range between 1 μm and 5,000 μm.

16. The drying system according to claim 1, further comprising a drying agent bag, wherein the drying agent is arranged in the drying agent bag and the drying agent bag is received in the receiving chamber.

17. A dryer cartridge for a drying system for removal of water from a liquid, wherein the drying system comprises a device for receiving the liquid, the dryer cartridge comprising:
a cartridge body and a connection head arranged at the cartridge body;
wherein the cartridge body comprises a cartridge body wall delimiting a receiving chamber, at least in sections thereof, wherein the cartridge body wall is configured to allow the liquid to pass into and out of the receiving chamber;
a drying agent received in the receiving chamber;
wherein the connection head of the dryer cartridge is configured to be fastened to a housing wall of the device for receiving the liquid and configured to secure the dryer cartridge at the device for receiving the liquid so that the cartridge body is fixed relative to the housing wall.

18. A method of drying a liquid in a device for receiving the liquid, the method comprising:
providing a dryer cartridge, comprising a cartridge body and a connection head arranged at the cartridge body, wherein the cartridge body comprises a cartridge body wall delimiting a receiving chamber, at least in sections thereof, wherein the cartridge body wall is configured to allow the liquid to pass into and out of the receiving chamber, wherein a drying agent is received in the receiving chamber;
fastening the connection head of the dryer cartridge to a housing wall of the device for receiving the liquid to secure the dryer cartridge at the device for receiving the liquid so that the cartridge body is fixed relative to the housing wall and to expose the liquid to the drying agent received in the receiving chamber.

19. The method according to claim 18, further comprising;
immersing a first region of the dryer cartridge in the liquid and arranging a second region of the dryer cartridge in a head space above the liquid, wherein the drying agent in the first region comprises a drying agent for absorbing water from the liquid and wherein the drying agent in the second region comprises a drying agent for absorbing water from air.

20. The method according to claim 18, further comprising selecting the liquid from the group consisting of an electrically nonconducting insulation oil, a cooling oil, and a cooling agent.

21. The method according to claim 20, wherein the insulation oil contains a polyol ester oil; a poly-alpha-olefin; or a polyol ester oil and a poly-alpha-olefin.

22. The method according to claim 18, wherein the device for receiving the liquid comprises at least one of a transmission, an electric motor, a fuel cell, a transformer, a rechargeable battery, and a thermal management system.
